(19) United States
(12) Patent Application Publication
(10) Pub. No.: US 2015/0069070 A1
(43) Pub. Date: Mar. 12, 2015

(54) VEHICLE FUEL TANK

(71) Applicant: MITSUBISHI JIDOSHA KOGYO KABUSHIKI KAISHA, Tokyo (JP)

(72) Inventors: Norifumi Iwaya, Obu-shi (JP); Hiroaki Kageyama, Nagoya-shi (JP); Takayuki Sano, Okazaki-shi (JP); Kenichi Kunii, Okazaki-shi (JP)

(73) Assignee: MITSUBISHI JIDOSHA KOGYO KABUSHIKI KAISHA, Tokyo (JP)

(21) Appl. No.: 14/391,616

(22) PCT Filed: Mar. 21, 2013
(86) PCT No.: PCT/JP2013/058063

§ 371 Date: Oct. 9, 2014

(30) Foreign Application Priority Data
Apr. 10, 2012 (JP) 2012-089200

(51) Int. Cl. B60K 15/077

(52) U.S. Cl. CPC B60K 15/077; B60K 2015/0777
USPC 220/563

(57) ABSTRACT

A vehicle fuel tank according to the present invention has a structure in which a chamber space (10) of a baffle body (6) is formed at a point away from an inner surface of a tank body (1).

### TECHNICAL FIELD

The present invention relates to a vehicle fuel tank and particularly relates to improvement of a structure for suppressing a flow noise of fuel.

### BACKGROUND ART

In a fuel tank mounted on an automobile (vehicle), fuel stored therein can easily flow, and the fuel flows in the tank and collides against an inner surface of the fuel tank or the fuel bounced back by the inner surface collides against the stored fuel at start or acceleration/deceleration during traveling, which can easily cause disturbing flow noises.

In the fuel tank, in order to reduce this flow noise, flow energy of the fuel is to be reduced by using a baffle body. For such reduction of the flow energy, a method of forming a chamber space holding the fuel in the fuel tank so as to make the fuel difficult to move is employed in many cases.

Conventionally, as such chamber space for making the fuel difficult to move, a structure of forming the chamber space as a closed space in which the inner wall of the tank body of the fuel tank is formed as it is as a wall portion of the chamber space is employed by using a baffle plate and an inner wall of a tank body of the fuel tank as disclosed in FIG. 6 of Patent Document 1, and the fuel is surrounded by the chamber space so as to make the fuel difficult to move and to suppress the flow energy colliding against the inner wall of the tank body. It is needless to say that the stored fuel can flow in/out of the chamber space.

### PRIOR ART DOCUMENT

### Patent Document

Patent Document 1: Japanese Patent Laid-Open No. 2007-307918 (see FIG. 6)

### SUMMARY OF THE INVENTION

### Problems to be Solved by the Invention

However, that structure also has a problem. That is, the wall portion of the tank body constitutes a wall portion of the chamber space. Thus, a noise caused by the fuel moving in the chamber space and the flow noise generated when the fuel collides are directly transmitted to the wall portion of the tank body and leaks out of the tank body and can cause a factor of noises.

Thus, an object of the present invention is to provide a vehicle fuel tank which suppresses leakage of the flow noise of the fuel in the chamber space of the baffle body to the outside of the fuel tank.

### Means for Solving the Problems

A vehicle fuel tank described in claim 1 employs a structure in which a chamber space into/out of which stored fuel can flow is formed at a point away from an inner surface of a tank body for a baffle body in order to achieve the above described object.

In an invention described in claim 2, the chamber space of the baffle body is configured to occupy the most from a lower limit position to a full amount position of a fuel amount which can be stored in the fuel tank.

In an invention described in claim 3, the chamber space is configured to form a closed section by using a baffle plate member as a wall portion.

In an invention described in claim 4, the chamber space is configured to be formed having at least two inclined surfaces which are narrowed as they go toward the inner surface of the tank body and a wall portion having a corner portion on a tip end side formed by intersection of the inclined surfaces.

In an invention described in claim 5, the baffle body is configured to be supported by the tank body through the baffle plate member for support.

### Advantageous Effects of the Invention

According to the invention in claim 1, since the chamber space is located away from the inner surface of the tank body, not only that the flow energy colliding against the inner wall of the tank body is suppressed, but also that the flow noise of the fuel in the chamber space of the baffle body can be configured not to be directly transmitted to the tank body.

Thus, the flow noise leaking from the fuel tank is suppressed, and reduction of the noise can be realized.

According to the invention of claim 2, the flow noise leaking from the fuel tank can be suppressed in any stored amount of the fuel.

According to the invention in claim 3, the chamber space can be formed with a simple structure.

According to the invention in claim 4, the fuel bounced back from the inner surface of the tank body due to start and acceleration/deceleration or the like is diffused while being cut off by the corner portion and the inclined surface. Thus, the flow noise caused by the fuel bounced back from the inner surface of the tank body can be suppressed, and the flow noise of the fuel tank can be effectively reduced.

According to the invention in claim 5, alleviation of the flow energy by the baffle plate member for support is added to alleviation of the flow energy by the chamber space, and reduction of the flow noise can be further realized.

### BRIEF DESCRIPTION OF THE DRAWINGS

FIG. 1 is a partially cut-away perspective view of a vehicle fuel tank according to an embodiment of the present invention illustrated together with a baffle body attached to the tank.

FIG. 2 is a sectional view of the vehicle fuel tank along A-A line in FIG. 1.

FIG. 3 is a perspective view illustrating a chamber space structure of the baffle body.

FIG. 4 is an exploded perspective view of the baffle body.

### MODE FOR CARRYING OUT THE INVENTION

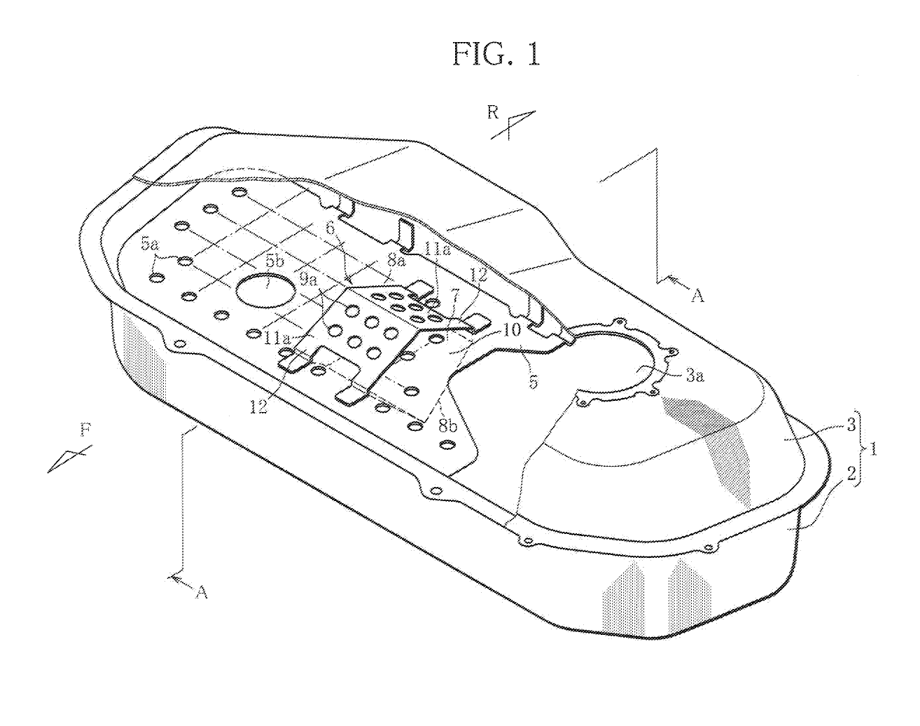

The present invention will be explained below on the basis of an embodiment illustrated in FIGS. 1 to 4.

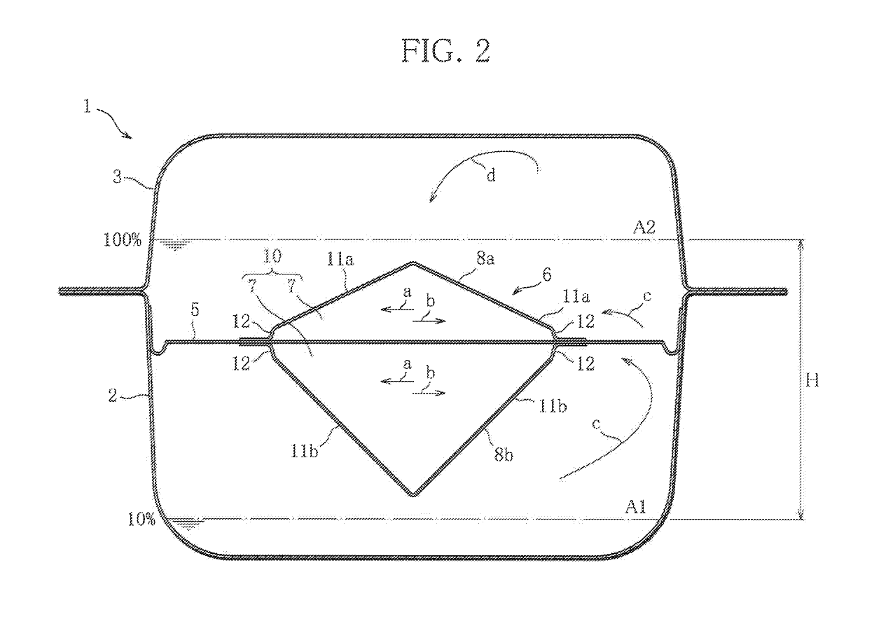

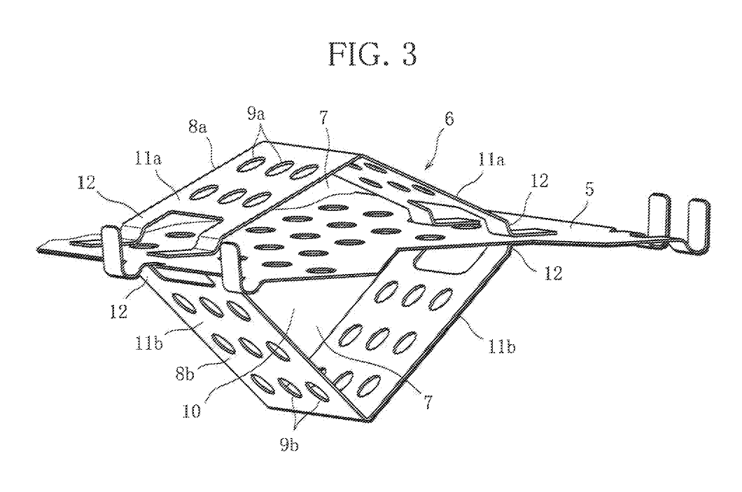

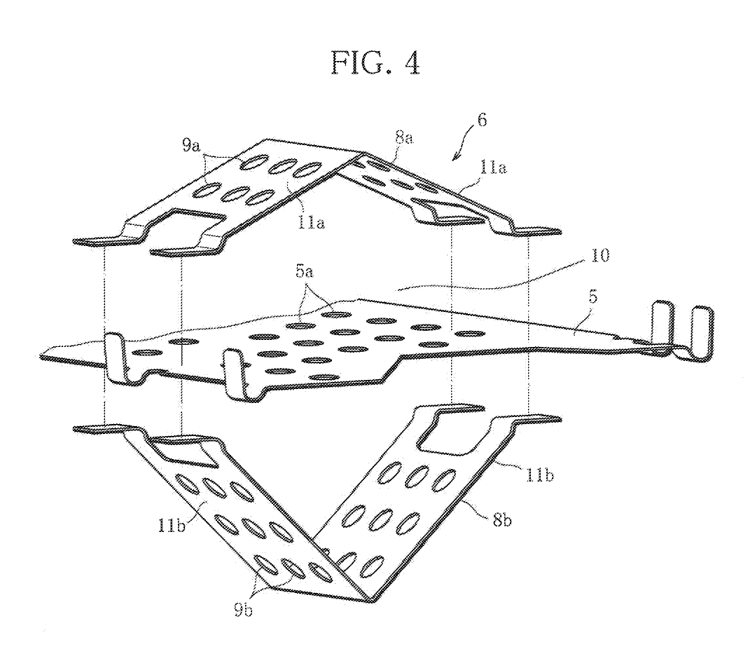

FIG. 1 illustrates an entire structure of a vehicle fuel tank (hereinafter referred to simply as a fuel tank) mounted below a floor of an automobile, for example, FIG. 2 illustrates a section along A-A line of the fuel tank, and FIGS. 3 and 4 illustrate a structure of a baffle body incorporated in the fuel tank. Reference character F in FIG. 1 denotes a front side of the vehicle, while reference character R denotes a rear side of the vehicle.

A structure of the fuel tank will be explained. Reference numeral 1 in FIG. 1 denotes a tank body of the fuel tank. The tank body 1 is formed by joining a lower tank 2 and an upper tank 3. The tank body 1 has a box shape in which a vehicle-width direction is long and a longitudinal direction of the vehicle is shorter than the vehicle-width direction, for example. A fuel pump module for supplying fuel to an engine (none of them is shown) is installed on one side in the vehicle-width direction of the tank body 1. A hole portion 3a on the one side in the vehicle-width direction of the upper tank 3 indicates a hole portion through which the fuel pump module goes in/out. A fuel-supply pipe member (not shown) for leading supplied fuel to the tank body 1 is connected to the opposite side, and the fuel is stored inside the tank body 1.

On the one side in the tank body 1 which avoids the fuel pump module, for example, a flat plate-shaped baffle plate member 5 (corresponding to a baffle plate for support of the present application) is provided so as to cross an inside of the tank body 1 as also illustrated in FIG. 2. This baffle plate member 5 is made of a flat plate-shaped plate in which a large number of through holes 5a are drilled. This baffle plate member 5 is arranged so as to vertically cross the space on a middle stage in the tank body 1. Moreover, a through hole 5b through which a fuel-supply pipe member passes is formed in a plate portion on a side opposite to the hole portion 3a of the baffle plate member 5.

On a region of the baffle plate member 5 which avoids a portion to become an obstacle such as the fuel-supply pipe member, the fuel pump module and the like, that is, a region from the center to the one side, for example, a baffle body 6 which is an essential part of the present invention is provided. The baffle body 6 is formed by a three-dimensional object (structure) forming a chamber space 10 holding the stored fuel without using a wall portion of the tank body 1 as illustrated in FIGS. 1 and 2.

Here, the baffle body 6, for example, uses a structure in which a pair of bent baffle plate members 8a and 8b each being bent into a mountain shape are assembled onto upper and lower surfaces of the baffle plate member 5 as illustrated in FIGS. 3 and 4 so as to form the chamber space 10 as a closed section at a point away from the inner surface of the tank body 1.

Specifically, for the bent baffle plate members 8a and 8b, baffle plate members both having mountain shapes and through holes 9a and 9b on the wall surface are used.

The chamber space 10 uses a structure in which these baffle plate members are attached to upper and lower surface portions of the baffle plate member 5 in an attitude with an axial direction directed to a vehicle-width direction and opening sides facing each other vertically (faced attitude) as illustrated in FIG. 4. Thus, a chamber space portion 7 having a triangular cylindrical shape with a vehicle-longitudinal direction becoming a closed space, respectively, is formed in a region surrounded by the baffle plate member 5 and the bent baffle plate members 8a and 8b. The chamber space 10 is formed of a space having a diamond-shaped section obtained by combining these two chamber space portions 7 and 7. In this way, the chamber space 10 is formed at the point away from the entire inner surface of the tank body 1. This chamber space 10 is supported by using the baffle plate member 5 crossing inside the tank body 1 described above as a supporting member. That is, the chamber space 10 is installed in the tank body 1 with a structure not using the wall portion of the tank body 1 as a side like conventional ones.

This chamber space 10 is, as illustrated in FIG. 2, arranged in the tank body 1 so as to occupy a horizontal direction inside the tank body as much as possible. The upper bent baffle plate member 8a forming the chamber space 10 in that extends to the vicinity of a full amount position A2 of the fuel tank, while the lower bent baffle plate member 8b extends to the vicinity of a lower limit position A1 of the fuel tank, and the chamber space 10 is arranged so as to occupy the most of a tank region H from the lower limit position A1 at which the fuel can be stored to the full amount position A2 of the fuel tank. Thus, it is so configured that the fuel can be held by the chamber space 10 in any stored state so that the fuel is made difficult to move in any state.

Moreover, the wall portions on the both sides in the vehicle longitudinal direction of the chamber space 10 and the upper side form a structure which can diffuse the fuel bounced back from the inner surface of the tank body 1 using the diamond sectional shape. That is, on the wall portions on the both sides in the vehicle longitudinal direction of the chamber space 10 and the upper side, two inclined surfaces 11a and 11b narrowed to each other as they go toward the inner surface of the tank body 1 and forming a diffusion portion, and a corner portion 12 formed at a portion where tip end portions of the inclined surfaces 11a and 11b intersect each other are formed by using the diamond sectional structure. That is, the structure is configured such that the corner portion 12 cuts off the fuel bounced back from the inner surface of the tank body 1 and the cut-off fuel is diffused by the inclined surfaces 11a and 11b.

According to the fuel tank configured as above, the fuel in the tank body 1 which is to flow upon behavior such as start of the vehicle or acceleration/deceleration during traveling as indicated by arrows a and b in FIG. 2, for example, is held in the chamber space 10 of the baffle body 6 and thus, it is difficult to move, and flow of the fuel is suppressed. The flow energy of the fuel is suppressed by this suppression.

At this time, since the chamber space 10 is arranged away from the entire inner surface of the tank body 1, the fuel in the chamber space 10 does not directly collide against the inner wall of the tank body 1. Thus, the flow noise caused by the collision is not directly transmitted to the wall surface of the tank body 1.

That is, by providing the chamber space 10 away from the entire inner surface of the tank body 1, not only the flow energy is suppressed but also the flow noise of the fuel in the chamber space 10 is kept from being directly transmitted to the tank body.

Thus, the flow noise leaking from the fuel tank can be suppressed, and the noise generated in the fuel tank can be reduced. Particularly, since the chamber space 10 of the baffle body 6 is arranged so as to occupy the most from the lower limit position A1 to the full amount position A2 of the fuel amount, the flow noise leaking from the fuel tank can be suppressed under any fuel stored amount.

Moreover, the chamber space 10 can be obtained only by forming a closed section by using the bent baffle plate members 8a and 8b as the wall portions, which is a simple structure.

Furthermore, by forming the wall portions of the chamber space 10, that is, by forming the wall portions on the both sides in the longitudinal direction and the upper side, here, by the wall portion having the two inclined surfaces 11a and 11b narrowed to each other as they go toward the inner surface of the tank body 1 and the corner portion 12 on the tip end side, the fuel bounced back from the inner surfaces of a side wall and an upper wall of the tank body 1 as indicated by arrows c and d in FIG. 2 has the flow energy suppressed by the behavior that the fuel is cut off by the corner portion 12 and diffused on the inclined surfaces 11a and 11b at start and acceleration/deceleration of the vehicle and the like. Thus, the flow noise caused by the fuel bounced back from the inner surface of the tank body 1 can be suppressed, and the flow noise of the fuel tank can be effectively reduced.

Particularly, if the baffle body 6 is supported by the tank body 1 by using the baffle plate member 5 forming the baffle plate for support, alleviation of the flow energy generated by the baffle plate member 5 is added to the alleviation of the flow energy generated by the chamber space 10, and the flow noise is further reduced.

The present invention is not limited to the above described embodiment but may be variously varied in practice within a range not departing from the gist of the present invention. For example, in the embodiment, a diamond shape combining triangular cylindrical shape is employed as the shape of the chamber space, but this is not limiting, and other shapes such as a square cylinder, a triangular cylinder or more polygonal cylinder and the like may be employed. It is needless to say that the chamber space does not have to be cylindrical and the periphery of a space may be fully closed, and the number does not have to be one but may be plural. In short, it is only necessary to form the chamber space without using the inner surfaces of the tank body. Moreover, the number of the inclined surfaces which diffuse the fuel while cutting it off does not have to be two but more inclined surfaces may be used for diffusion.

Moreover, in the embodiment, the fuel tank having a box shape extending uniformly in the vehicle-width direction is cited, but this is not limiting, and the fuel tank having a saddle shape may be similarly cited.

### EXPLANATION OF REFERENCE SIGNS

1 tank body
5 baffle plate member (baffle plate member for support)
6 baffle body
7 chamber space portion
8a, 8b bent baffle plate member (baffle plate member)
10 chamber space
11a, 11b inclined surface
12 corner portion

1.-7. (canceled)

8. A vehicle fuel tank having a tank body mounted on a vehicle and storing fuel and a baffle body disposed in the tank body, wherein
the baffle body has baffle plate members and a baffle plate member for support that supports the baffle plate member on the tank body, a chamber space in/out of which stored fuel in the tank body can flow is formed by the baffle plate member and the baffle plate member for support, and the chamber space is arranged at a point away from an inner surface of the tank body.

9. The vehicle fuel tank according to claim 8, wherein
the baffle body is arranged between a lower limit position and a full amount position of a fuel amount that can be stored in the fuel tank.

10. The vehicle fuel tank according to claim 8, wherein
the chamber space of the baffle body is formed by a construction partitioned by the baffle plate member for support and in which a closed section is formed in a vehicle longitudinal direction by using the baffle plate members as a wall portion.

11. The vehicle fuel tank according to claim 8, wherein
the chamber space has the baffle plate members facing each other vertically and at least two inclined surfaces whose distance to each other is narrowed as they go toward the inner surface of the tank body and a corner portion on a tip end side formed on a portion where tip end portions of the inclined surfaces intersect through the baffle plate member for support.

12. The vehicle fuel tank according to claim 8, wherein
the baffle body is provided on upper and lower surfaces of the baffle plate member for support and formed of a pair of bent baffle plate members.

13. The vehicle fuel tank according to claim 8, wherein
the tank body has a length in a vehicle-width direction longer than a length in a vehicle longitudinal direction.

14. The vehicle fuel tank according to claim 11, wherein
inclined surfaces of the baffle plate members are formed in the vehicle longitudinal direction.
